(19) United States
(12) Patent Application Publication
(10) Pub. No.: US 2006/0022358 A1
(43) Pub. Date: Feb. 2, 2006

(54) Distributed bubble generating system

(76) Inventors: Yong Min Cho, Silver Spring, MD (US); Philip Y. Kim, Silver Spring, MD (US)

Correspondence Address: HARNESS, DICKEY & PIERCE, P.L.C., P.O. BOX 8910, RESTON, VA, 20195, US

(21) Appl. No.: 10/901,418

(22) Filed: Jul. 30, 2004

(51) Int. Cl. B01F 3/04

(52) U.S. Cl. 261/23.1; 261/122.1

(57) ABSTRACT

The distributed bubble generating system intakes air and delivers this air at maximum capacity to the solution in the long-channel shape bubble generating units. The air is blown through the firm sponge type filters of the bubble generating units, which are submerged in the solution. This configuration provides the capability of rapid and effective generation of bubbles.

### BACKGROUND OF THE INVENTION

The distributed bubble generating system is a new and more effective fire suppression technology. The concept is that an environmentally safe solution passes through multiple distributed long-channel shape bubble generating units to generate long-lasting, relatively dry bubbles. In an enclosed space, such as a warehouse or the engine room of a ship, the area will be treated by the distributed bubble generating system, which is able to produce a massive volume of bubbles to overwhelm and extinguish the fire. The distributed bubble generating system is able to produce a massive volume of bubbles rapidly, depriving the fire of oxygen in enclosed areas.

### SUMMARY OF THE INVENTION

The distributed bubble generating system uses a massive volume of relatively dry bubbles to blockade the oxygen supply to the fire. This system is most effective in blockading the oxygen supply while fighting large fires in an enclosed space. To blockade the oxygen supply effectively, the key issue is the speed in which the bubbles are generated. To quickly produce a large volume of the bubbles, multiple long-channel shape bubble generating units should be distributed over the ceiling of the area.

### BRIEF DESCRIPTION OF THE DRAWING

This invention can be fully understood through reference to the following figures and brief description below:

FIG. 1 is a conceptual functional block diagram of the system using distributed multiple long-channel shape bubble generating units.

FIG. 2 is a conceptual side view of the single long-channel shape bubble generating unit.

### DETAILED DESCRIPTION OF THE DRAWING

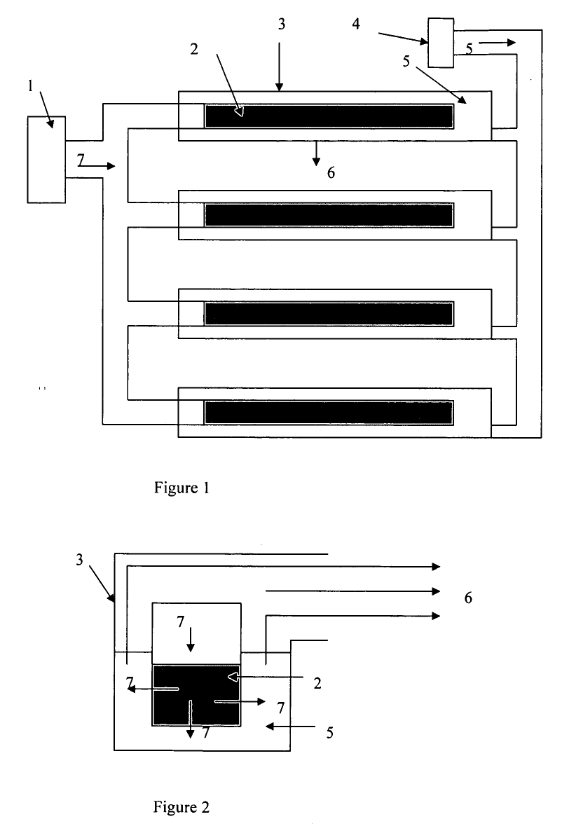

In FIG. 1, the air supplier 1 feeds air 7 through the system. At the same time, the solution supplier 4 feeds solution 5 through the system. The solution flows into each long-channel shape bubble generating unit 3, submerging the firm sponge type filter 2. The air 7 is blown through the submerged firm sponge type filters 2, producing bubbles in the solution 5. The bubbles 6 are blown out of the system to distinguish fires.

In FIG. 2, a cross section of a single long-channel shape bubble generating unit 3 is shown. The air 7 flows through the firm sponge type filter 2, which is submerged in a pool of solution 5. Bubbles 6 are produced, which flow out of the system by the shown route.

I claim:

1. The distributed bubble generating system that uses multiple distributed long-channel shape bubble generating units.

2. Any shape of the submerged firm sponge type filter claimed in 1.

3. Any shape of the long-channel shape bubble generating unit claimed in 1.
